(19) United States
(12) Patent Application Publication
(10) Pub. No.: US 2025/0036544 A1
(43) Pub. Date: Jan. 30, 2025

(54) METHOD FOR NON-REACTIVE VALIDATION OF A FUNCTION APPLICATION

(71) Applicant: Robert Bosch GmbH, Stuttgart (DE)

(72) Inventors: Klaus Grabmaier, Gerlingen (DE); Wolfgang Hauch, Stuttgart (DE); Rainer Strohmaier, Stuttgart (DE)

(21) Appl. No.: 18/705,380

(22) PCT Filed: Oct. 27, 2022
(86) PCT No.: PCT/EP2022/080065

§ 371 Date: May 29, 2024

(30) Foreign Application Priority Data
Oct. 27, 2021 (DE) 10 2021 212 116.0

(51) Int. Cl. G06F 11/36

(52) U.S. Cl. CPC G06F 11/3604

(57) ABSTRACT

A method for non-reactive validation of a function application for a host system that has host system resources and is configured to execute a control program to implement control functions of a device. The method includes: providing an environment in the host system, to which are assigned certain environment resources of the host system resources that computer programs executed in the environment are permitted to have at most; sending data present in the host system outside the environment, into the environment via a unidirectional interface; executing the function application in the environment to determine validation function data based on the data sent into the environment; determining validation data including function data and/or data derived from function data; sending the validation data to a remote computing system via a data communication interface of the host system.

### FIELD

The present invention relates to a method for non-reactive validation of a function application, to a computing unit and a computer program for carrying out said method, and to a validation system.

### BACKGROUND INFORMATION

For the development and validation of (highly) automated driving functions and, more generally, for other automated technical systems, a high level of test penetration that can no longer be achieved by traditional means is required. System tests and endurance tests using a dedicated vehicle test fleet allow known situations to be detected and made safe. However, in real operation, rare events also play a role, the detection of which requires a much higher number of vehicles and corresponding mileage.

### SUMMARY

According to the present invention, a method for non-reactive validation of a function application, a computing unit and a computer program for carrying out said method, and a validation system are provided. Advantageous example embodiments of the present invention are disclosed herein.

The present invention makes use of the measure of executing the function application in the host system in an (encapsulated) environment. According to an example embodiment of the present invention, data are sent from the control program to the function application via a unidirectional interface so that the control program cannot be influenced by the function data or the function application. The function data determined in this case by the function application (referred to as validation function data), or validation data determined therefrom, are sent for validation to a remote computing system via a data communication interface of the host system, independently of the control program. This allows testing of the function application in real operation of the device, which is in particular an autonomous or semi-autonomous vehicle, without the function application influencing the control program and possibly leading to errors in the control of the device. In particular, it is also advantageous that a much larger number of situations can arise in real operation and be taken into account in the validation than is the case in the case of a validation using simulations or the like. Certain resources of the host system are made available to the environment and thus to the function application and can be selected (low) so that sufficient resources are available for the control program.

The host system (computing unit) is provided in a device (such as a machine or vehicle), for example as a control unit of the device, and has certain host system resources. These are certain hardware resources, for example processors with a certain computing power, volatile and/or non-volatile memories with a certain memory bandwidth and a certain memory volume and/or the like. The host system is configured to execute a control program in order to implement control functions of the device.

The function application is a computer program or computer program module that is configured, when executed, to determine function data that influence the control functions if the function application is executed as part of the control program and/or if the function data are taken into account by the control program. The function application is thus a potential computer program module of the control program that is to be validated and is to be integrated into or to provide data for the control program in order to influence the control functions (in real use).

According to an example embodiment of the present invention, in the host system, an environment is provided to which certain environment resources of the host system resources are assigned that computer programs executed in the environment are permitted to have at most. For example, the environment may be assigned a certain maximally usable processor performance or certain memory regions. In particular, the environment should be provided such that it is not possible to influence the control program or other programs executed in the host system outside the environment; for example, the environment or the function application or another program executed therein cannot access host system resources that are not assigned to the environment. For example, access to memory regions that are not assigned to the environment is not possible from the environment.

Data from the host system are sent into the environment via a unidirectional interface. That is to say, (specified) data that are available in the host system outside the environment, for example sensor data or data/parameters of the control program, are sent from outside the environment into the environment via the unidirectional interface. In the environment, executing the function application is effected in order to determine validation function data on the basis of the data sent into the environment, wherein in particular the function application is not executed as part of the control program and/or the validation function data are not taken into account by the control program. Further, determining the validation data is effected, wherein the validation data comprise function data and/or data derived from function data, and sending or transmitting the validation data to a remote computing system through a data communication interface of the host system is effected. In addition to function data and/or data derived therefrom, the validation data can also comprise further data, in particular metadata, which are detected by the environment and/or the function application.

According to an example embodiment of the present invention, the remote computing system can comprise one or more computing units, which are suitable for executing computer programs that implement the function of the computing system. It is also possible that the computing system is implemented partially or completely in the form of virtualized computing units on a system of computing units (server, server system). In particular, an implementation as a so-called cloud service is possible.

According to an example embodiment of the present invention, preferably, the method comprises providing the function application in the environment, wherein the function application is preferably provided by the remote computing system via the data communication interface. This allows checking other function applications or a plurality of versions of the function application (consecutively).

According to an example embodiment of the present invention, preferably, the environment resources comprise a maximum processor utilization, a maximum amount of volatile memory, a maximum amount of non-volatile memory, and/or a maximum bandwidth of the data communication interface. The environment resources (which are assigned to the environment) can be selected such that sufficient resources are available for the control program.

According to an example embodiment of the present invention, preferably, the method comprises reducing the environment resources if a resource request from the control program exceeds a predetermined threshold. In this way, it can be ensured that the control program always has sufficient resources (within the framework of the maximum host system resources), even if the control program requires an unexpected number of resources. In extreme cases, the environment resources assigned to the environment, or at least some of them, can be reduced to zero, which can lead to a termination of the function application. The predetermined threshold is preferably determined on the basis of the host system resources not assigned to the environment (i.e., host system resources minus environment resources), taking into account a resource reserve. The predetermined threshold is preferably determined as host system resources minus environment resources minus resource reserve. The resource reserve can be specified by absolute resource information or by relative resource information. Relative resource information can be specified in particular in relation to the host system resources not assigned to the environment (host system resources minus environment resources). For example, this could be 10% or 20% of the host system resources not assigned to the environment, so that the environment resources are reduced if the resource request from the control program reaches or exceeds 90% or 80% of the host system resources not assigned to the environment. Conversely, it can be provided that the environment resources are increased again, preferably to the originally assigned value, if the resource request from the control program is below a (second) threshold for a certain period of time (for example, a few seconds or a few minutes), for example below 50% of the host system resources not assigned to the environment.

According to an example embodiment of the present invention, preferably, the method comprises specifying in the unidirectional interface which data from the host system (or which data present in the host system outside the environment) are sent into the environment to the function application, wherein specifying preferably is effected when providing the function application in the environment. That is to say, the type of data that are sent is specified. In particular, this can comprise sensor data from sensors of the device, control data or control commands of the control program and/or certain processing data that are generated when executing the control program, for example as intermediate values in processing steps of input data of the control program.

According to an example embodiment of the present invention, preferably, the method comprises validating the function application by the remote computing system on the basis of the validation data. When validating the function application by the remote computing system, the validation data are analyzed or checked by the remote computing system. This embodiment allows analyzing and checking as to whether the validation data (in particular function data, if included in the validation data) correspond to expected validation data (in particular expected function data) (which were, for example, provided for during the design or programming of the function application), and/or whether the validation data (in particular function data) are within permissible values, and/or the like. If this check is successful, the function application is deemed to be validated or successfully validated. Otherwise, the function application is deemed to be not validated.

According to an example embodiment of the present invention, if the function application is not validated, providing, by the remote computing system, a modified function application and/or modifications to the function application in the environment via the data communication interface is preferably effected. In this way, a further version of the function application can be checked. The modifications can be based in particular on the validation data of the previous version(s).

According to an example embodiment of the present invention, if the function application is successfully validated, providing the function application is preferably effected in the host system as part of the control program and/or such that the function data are taken into account by the control program. In the case of successful validation, the function application can thus actually be deployed since validation ensures (with a high degree of probability) that it works as desired or intended and does not lead to malfunctions, for example.

According to an example embodiment of the present invention, preferably, a lower execution priority is assigned to the environment and/or the function application than to the control program. Thus, processes that belong to the control program are preferentially assigned corresponding processor resources by a process scheduler (in comparison to processes that belong to the environment/function application). In this way, a possible (indirect) influence on the control program by the function application can be further suppressed.

According to an example embodiment of the present invention, preferably, the device is an autonomous or semi-autonomous vehicle, wherein the control functions preferably relate to automatically carried-out driving functions of the vehicle (i.e., driving functions implemented as part of the autonomy or semi-autonomy of the vehicle). In particular, it can be an autonomous or semi-autonomous vehicle corresponding to SAE Level 2, 3 or higher (SAE International: J3016 Levels of Driving Automation). The use of the method according to the present invention in an autonomous or semi-autonomous vehicle is expedient since a vehicle in real operation can be exposed to many traffic situations that cannot be foreseen when designing the function application.

A computing unit (host system) according to the present invention, for example a control unit of a vehicle, is configured, in particular in terms of programming, to carry out a method according to the present invention.

A validation system according to the present invention comprises at least one computing unit according to the present invention and a remote computing system that is configured to establish a data connection with a data communication interface of the at least one computing unit and to receive validation data for at least one function application via the data connection. According to an example embodiment of the present invention, preferably, the validation system comprises a plurality of computing units according to the present invention, wherein, in particular, validation data for the same function application can be received from a plurality of computing units.

According to an example embodiment of the present invention, preferably, the remote computing system is further configured to provide at least one function application via the data connection in the at least one computing unit and/or to validate at least one function application on the basis of received validation data and/or to modify the at least one function application and to provide the modified at least one function application via the data connection in the at least one computing unit. Preferably, the validation system comprises a plurality of computing units, wherein the validation data of different computing units that relate to the same function application or different versions of the same function application are taken into account during the validation.

Furthermore, the implementation of a method according to the present invention in the form of a computer program or computer program product having program code for carrying out all the method steps is advantageous because it is particularly low-cost, in particular if an executing control unit is also used for further tasks and is therefore present anyway. A machine-readable storage medium is also provided with a computer program as described above stored thereon. Suitable storage media or data carriers for providing the computer program are, in particular, magnetic, optical, and electric storage media, such as hard disks, flash memory, EEPROMs, DVDs, and others. It is also possible to download a program via computer networks (Internet, intranet, etc.). Such a download can be wired or wireless (e.g., via a WLAN network or a 3G, 4G, 5G or 6G connection, etc.).

Further advantages and embodiments of the present invention can be found in the description and the figures.

The present invention is shown schematically in the figures on the basis of exemplary embodiments and is described below with reference to the figures.

### BRIEF DESCRIPTION OF THE DRAWINGS

FIG. 1 illustrates the structure of an exemplary system with which the method for non-reactive validation of a function application can be implemented, according to an example embodiment of the present invention.

FIG. 2 shows a flow chart according to a preferred example embodiment of the present invention.

### DETAILED DESCRIPTION OF EXAMPLE EMBODIMENTS

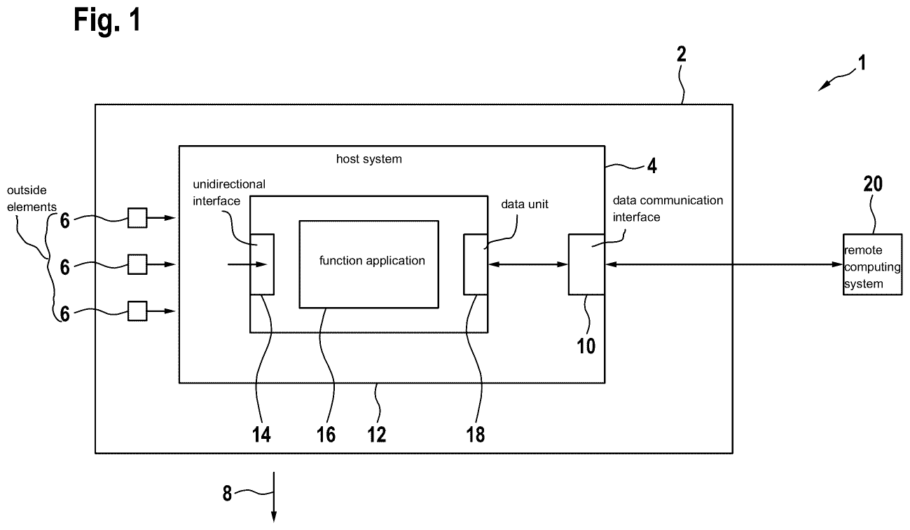

FIG. 1 illustrates the structure of an exemplary system 1 (validation system) with which the method for non-reactive validation of a function application can be implemented. The system comprises a host system 4 that implements control functions of a device 2 by executing at least one control program. The host system 4 is a computing unit, for example a control unit, and has one or more processors with one or more computing cores, a volatile memory, a non-volatile memory, and/or at least one interface for receiving and sending data (not shown in detail). These elements of the host system 4 or services provided by it, for example computing power, storage space, bandwidth, represent resources of the host system 4 or host system resources.

For example, the host system 4 can comprise an interface in order to receive data (also referred to as external data) from elements 6 of the device outside the host system 4. External data can, for example, be sensor data from sensors that detect the states of the device 2 and/or an environment of the device, operating signals and/or messages from elements controlled by the control program. The control program (not shown in detail) can be configured to process the sensor data and/or any other data (such as operating signals from operating elements of the device or stored control specifications) and/or the like in order to determine processed data (also referred to as internal data) based thereon. The processed data 8 can be transmitted to elements of the device in order to control these elements. In this way, (when it is executed) the control program can implement control functions of the device.

A data communication interface 10 is also shown, with which the host system 4 and thus computer programs executed in it (if permitted in each case) can communicate with devices outside the device 2, i.e., can exchange data.

In the host system 4, independently of the control program, an environment or encapsulated environment 12 is provided, to which certain resources of the host system resources, referred to as environment resources, are assigned; the environment is characterized, so to speak, by the assigned environment resources. In particular, environment resources can be a maximum processor utilization, a maximum amount (storage space) of volatile memory, a maximum amount of non-volatile memory, and/or a maximum bandwidth of the data communication interface. Thus, computer programs executed in the environment 12 can utilize the resources of the host system 4 until the environment resources are reached.

A unidirectional interface 14 is provided, via which data can be sent into the environment 12 or to computer programs executed therein. Thus, data from the control program and/or sensor data can be sent into the environment 12. Which data are sent can be specified in the unidirectional interface 14, i.e., it can be specified which type of data or which specific data, for example which parameters, are sent into the environment. For example, this can be detected data from a specified sensor and/or specified data or parameters (for example, internal parameters or control commands) that are used or determined by the control program (also referred to as data present in the control program) when the control program is executed. Thus, a subset or the entire set of internal and/or external data can be specified in the unidirectional interface 14 as data to be sent or transmitted into the environment 12.

The environment 12 or a computer program executed therein can also communicate with devices or computers outside the device 2 via the data communication interface 10. This can also only take place within the framework of the assigned environment resources, in this case the assigned maximum bandwidth of the data communication interface. This communication from the environment 12 via the data communication interface 10 is effected independently of computer programs executed in the host system outside the environment, in particular independently of the control program, i.e., without functionalities of the control program being used or influenced.

A function application 16, which is a computer program, is executed in the environment 12. The function application 16 is configured to determine function data that, if taken into account by the control program, would influence the control functions. The function application 16 can be regarded as a potential program module (to be validated) that is to be integrated into the control program or that determines the function data for use (further processing) by the control program. If the function application 16 is executed in the environment 12, the certain function data are not taken into account by the control program and is more specifically referred to as validation function data.

The data required by the function application 16 in order to determine the function data can be specified in the unidirectional interface 14. A direct effect of the function application 16 on the host system outside the environment 12 is not possible due to the unidirectional nature of the interface 14. In particular, no direct effects (for example, by modifying registers or data) on the control program are possible. Indirect effects can arise if the control program requires more resources than expected, so that it has a resource requirement that overlaps with the environment resources. Such indirect effects can be counteracted by limiting the resources of the environment; i.e., the environment resources assigned to the environment can be reduced in this case.

So-called validation data, which can be transmitted to a remote computing system 20 via the data communication interface 10, are determined from the validation function data determined by the function application 16 or from data derived therefrom. Derived data can be a selection of certain validation function data and/or data determined on the basis of the validation function data (such as an average of certain validation function data or the like). In the case of a selection of certain validation function data as derived data, data from certain sensors or values from certain (control program) parameters can be used, for example. It can also be provided that derived data are determined only if it is recognized (for example, on the basis of sensor data) that the device is in at least one predefined operating situation. In addition to the validation function data or the data derived therefrom, the validation data can optionally also comprise further data. In particular, it can be provided that the validation data comprise resource data indicating an actual resource consumption of the function application.

In order to determine the validation data, a data unit 18 can be provided (in the environment). It can be provided that the validation function data or the data derived therefrom and/or also the validation data are recorded and temporarily stored by the data unit 18. This is in particular helpful if the connection between the data communication interface 10 and the remote computing system 20 is not uninterrupted.

The transmitted validation data can be analyzed by the remote computing system 20 in order to validate the function application. In the case of successful validation, it can be provided that the function application is deployed in the host system in order to influence control functions, i.e., that the function application can be used as part of the control program or certain function data determined by the function application can be taken into account by the control program. For example, a (software) update of the computer programs (control programs) executed by the host system can be effected by the remote computer system 20 via the data communication interface 10. If the validation of the function application 16 fails, it can be provided that a different and/or modified function application is provided in the environment 12 via the data communication interface 10 by the remote computing system 20 in order to validate it. It can also be provided that different versions of the function application are provided in sequence in the environment 12 via the data communication interface 10 by the remote computing system 20, and validation is effected only after the validation data of the different versions have been transferred to the remote computing system 20. As a result, a particularly suitable version of the function application can be selected during the validation. It can also be provided that the function application is used for validation in a plurality of similar devices; i.e., the function application is provided and executed in environments in respective host systems of the plurality of devices in order to determine respective validation data and transmit them to the remote computing system. The validation data from the plurality of devices can then be taken into account in the validation of the function application by the remote computing system.

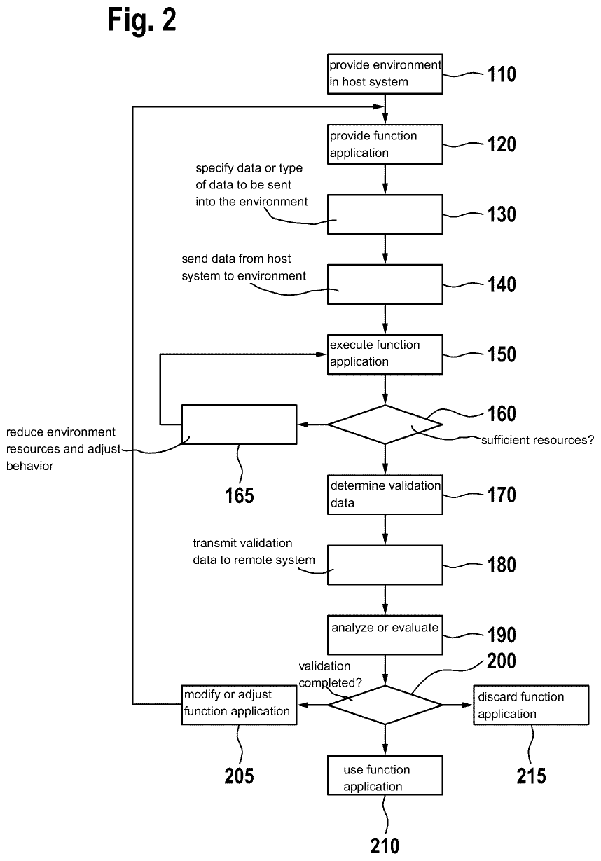

FIG. 2 shows a flow chart according to a preferred embodiment of the present invention.

In step 110, the environment is provided in the host system, wherein certain environment resources are assigned to the environment. Assignment can be effected using the corresponding resource allocation functionality of the host system. The environment resources are part of the host system resources and determine those of the host system resources that are allowed to be used at most by the environment.

In step 120, the function application is provided in the environment. For example, the function application can be transferred into the environment via the data communication interface (for example, from the remote computing system or another remote computing unit) and stored there in a volatile or non-volatile memory (within the framework of the environment resources). Providing by connecting a non-volatile memory to an interface (which can be regarded as part of the data communication interface) of the host system, for example, by means of a suitable connector, and transferring from this non-volatile memory into the environment is also possible.

In an optional step 130, which can also be carried out prior to or simultaneously with step 120 or as part of step 120, the data, or type of data, to be sent into the environment are specified in the unidirectional interface. In general, it is also possible that an amount of data to be sent is predefined (for example, with the provision of the environment) so that the data to be sent into the environment do not have to be specified separately.

In step 140, sending (specified) data from the host system to the environment via the unidirectional interface is effected or begins. The sending of the data is carried out continuously at least during the subsequent step 150 (execution of the function application). The data sent are thus provided in the environment and can be used by computer programs executed therein, in particular by the function application.

In step 150, executing the function application in the environment is effected; i.e., the function application is started or execution of the function application begins. Execution is effected such that the environment resources are not exceeded. This can be ensured by the resource allocation functionality of the host system and/or a corresponding functionality of the environment. If the environment resources are not sufficient to execute the function application or to execute it such that the intended function of the function application is achieved, a corresponding error message can be generated, in particular as part of the validation data, and can optionally be transmitted to the remote computing system.

The function application uses the data sent into the environment, in order to determine function data referred to as validation function data. The function application is executed continuously, wherein it can also be provided that the execution is terminated after a certain period of time or in response to certain events. The latter can occur in particular if it is determined that the execution of the control program requires too many host system resources, so that the simultaneous execution of the function application would not be possible without (indirectly) influencing the control program.

In a preferred step 160, it is checked, for example by the resource allocation functionality, whether sufficient resources are available outside the environment so that the execution of the control program is not impaired. If there are not enough resources available for executing the control program outside the environment, it is possible in a preferred step 165 to reduce the environment resources and to adjust the behavior to the environment resources that are actually available. At the same time, a corresponding error message can be generated, in particular as part of the validation data, and optionally transmitted to the remote computing system.

In step 170, validation data are determined on the basis of the validation function data determined by the function application, which validation data can be used to validate the function application, i.e., to check whether it is working as intended. The validation data can comprise the validation function data themselves, a subset thereof, data derived from the validation function data, and/or metadata generated in the execution of the function application (for example, actual resource consumption, execution times, or the like and/or, in particular, data detected by the environment when the function application is executed).

In step 180, the validation data are transmitted to the remote computing system via the data communication interface. This transmission can be effected continuously or at regularly or irregularly spaced points in time (for example, if the connection via the data communication interface does not always exist). It can also be provided that the validation data are transmitted if (or in response to) a certain amount (for example, measured in bytes, kilobytes, . . . ) is present.

In a preferred step 190, the validation data transmitted to the remote computing system are analyzed or evaluated by the remote computing system in order to validate the function application, i.e., to determine whether the function application is working as desired. The remote computing system can initially collect a certain (sufficient) amount of validation data, in particular from copies of the function application that are executed in host systems of a plurality of devices within respective environments.

In a preferred step 200, it is checked whether the validation of the function application has been completed. If the validation has not been completed, for example because there are not yet sufficient validation data or because other versions of the function application are to be checked, for example with modified parameters, the function application can be provided again in the environment, i.e., a jump back to step 120 can be made, wherein a modification or adjustment of the function application can optionally be effected beforehand in step 205 in order to obtain a different version.

If the validation has been completed and if the function application has been successfully validated (i.e., if it was determined in the validation in step 190 that the function application works as desired), the function application can be used in an optional step 210. In this case, the function application is installed on the host system so that the function application influences the control functions. On the other hand, if the validation has been completed and if the function application has not been successfully validated, the function application can be discarded in an optional step 215.

1-15. (canceled)

16. A method for non-reactive validation of a function application for a host system that has host system resources and is configured to execute a control program to implement control functions of a device, wherein the function application is a computer program that is configured, when executed, to determine function data that influence the control functions when the function application is executed as part of the control program and/or when the function data are taken into account by the control program, the method comprising the following steps:
providing an environment in the host system, the environment being assigned certain environment resources of the host system resources that computer programs executed in the environment are permitted to have at most;
sending data present in the host system outside the environment, into the environment via a unidirectional interface;
executing the function application in the environment to determine validation function data based on the data sent into the environment;
determining validation data, the validation data including function data and/or data derived from function data;
sending the validation data to a remote computing system via a data communication interface of the host system.

17. The method according to claim 16, further comprising:
providing the function application in the environment;
wherein the function application is provided by the remote computing system via the data communication interface.

18. The method according to claim 16, wherein the environment resources include a maximum processor utilization, and/or a maximum amount of volatile memory, and/or a maximum amount of non-volatile memory, and/or a maximum bandwidth of the data communication interface.

19. The method according to claim 16, further comprising:
reducing the environment resources when a resource request from the control program exceeds a predetermined threshold.

20. The method according to claim 16, further comprising:
specifying in the unidirectional interface which data present in the host system outside the environment are sent into the environment to the function application;
wherein the specifying is effected when providing the function application in the environment.

21. The method according to claim 16, wherein a lower execution priority is assigned to the environment and/or the function application than to the control program.

22. The method according to claim 16, further comprising:
validating the function application by the remote computing system based on the validation data.

23. The method according to claim 22, further comprising:
when the function application is not validated, providing, by the remote computing system, a modified function application and/or modifications of the function application in the environment via the data communication interface.

24. The method according to claim 22, further comprising:
when the function application is successfully validated: providing and/or deploying the function application in the host system as part of the control program and/or such that the function data are taken into account by the control program.

25. The method according to claim 16, wherein the device is an autonomous or a semi-autonomous vehicle; and wherein the control functions relate to automatically carried-out driving functions of the vehicle.

26. A computing unit including a control unit of an autonomous or semi-autonomous vehicle, the computing unit configured for non-reactive validation of a function application for a host system that has host system resources and is configured to execute a control program to implement control functions of a device, wherein the function application is a computer program that is configured, when executed, to determine function data that influence the control functions when the function application is executed as part of the control program and/or when the function data are taken into account by the control program, the computing unit configured to:
provide an environment in the host system, the environment being assigned certain environment resources of the host system resources that computer programs executed in the environment are permitted to have at most;
send data present in the host system outside the environment, into the environment via a unidirectional interface;
execute the function application in the environment to determine validation function data based on the data sent into the environment;
determine validation data, the validation data including function data and/or data derived from function data;
send the validation data to a remote computing system via a data communication interface of the host system.

27. A validation system, comprising:
at least one computing unit; and
a remote computing system that is configured to establish a data connection with a data communication interface of the at least one computing unit and to receive validation data via the data connection;
wherein the computing unit is configured for non-reactive validation of a function application for a host system that has host system resources and is configured to execute a control program to implement control functions of a device, wherein the function application is a computer program that is configured, when executed, to determine function data that influence the control functions when the function application is executed as part of the control program and/or when the function data are taken into account by the control program, the computing unit configured to:
provide an environment in the host system, the environment being assigned certain environment resources of the host system resources that computer programs executed in the environment are permitted to have at most;
send data present in the host system outside the environment, into the environment via a unidirectional interface;
execute the function application in the environment to determine validation function data based on the data sent into the environment;
determine the validation data, the validation data including function data and/or data derived from function data;
send the validation data to a remote computing system via the data communication interface of the host system.

28. The validation system according to claim 27, wherein the remote computing system is further configured to:
provide the function application via the data connection in the at least one computing unit or an environment provided therein; and/or
validate the function application based on validation data; and/or
modify the function application and provide the modified function application via the data connection in the at least one computing unit or the environment provided therein.

29. A non-transitory machine-readable storage medium on which is stored a computer program for non-reactive validation of a function application for a host system that has host system resources and is configured to execute a control program to implement control functions of a device, wherein the function application is a computer program that is configured, when executed, to determine function data that influence the control functions when the function application is executed as part of the control program and/or when the function data are taken into account by the control program, the computer program, when executed by a computer, causing the computer to perform the following steps:
providing an environment in the host system, the environment being assigned certain environment resources of the host system resources that computer programs executed in the environment are permitted to have at most;
sending data present in the host system outside the environment, into the environment via a unidirectional interface;
executing the function application in the environment to determine validation function data based on the data sent into the environment;
determining validation data, the validation data including function data and/or data derived from function data;
sending the validation data to a remote computing system via a data communication interface of the host system.
